(19) United States
(12) Patent Application Publication
(10) Pub. No.: US 2005/0223926 A1
(43) Pub. Date: Oct. 13, 2005

(54) Apparatus for cleaning a rotating cylinder

(76) Inventor: Michael Baeten, Green Bay, WI (US)

Correspondence Address: John W. Chestnut;GREER, BURNS & CRAIN, Suite 2500, 300 South Wacker Drive, Chicago, IL, 60606-4002, US

(21) Appl. No.: 10/820,984

(22) Filed: Apr. 8, 2004

(51) Int. Cl. B41F 35/00

(52) U.S. Cl. 101/425; 101/424

(57) ABSTRACT

A plate cleaner for a printing press includes a cleaning head and a nozzle mounted on the cleaning head for directing pressurized fluid toward the plate cylinder of the printing press. The nozzle directs the pressurized fluid at an acute angle to a tangent to the cylinder in a direction opposite to the rotation of the plate cylinder. The cleaning head is provided with a suction port for removing contamination from the plate cylinder. The nozzle is located outside of the suction port.

### BACKGROUND

This invention relates to an apparatus for cleaning a rotating cylinder. More particularly, the invention relates to a plate cleaner for cleaning the printing surface of a plate cylinder on a printing press.

The invention is particularly useful for cleaning the plate cylinder of a flexographic printing press and will be explained in conjunction with such a press. However, it will be understood, that the invention is not limited to flexographic presses and can be used with other presses and with rotating cylinders other than printing plate cylinders.

Flexographic printing presses are commonly used for printing webs for making paper towels and bathroom tissue and for printing other products. Such a press includes an impression cylinder and at least one plate roll or cylinder. During the printing process, ink is transferred to the printing surface of the plates from another roll (typically an anilox roll). The web travels over the impression cylinder. As the web travels over the impression roll it contacts the printing surface of the printing plates. The ink is transferred from the plates to the web. When towel and tissue webs are printed, loose paper fibers and ink tend to stick to the printing plate. The contamination can be seen on the printed product and produces an undesirable image.

The plate cleaning device of the invention removes the contamination from the printing plates and reduces (or eliminates) the need to manually clean the plates.

In all present art, the cleaning nozzle is positioned at a 90° angle to the printing plate. The problem with the present art is that typically the cleaning nozzle does not have enough force to blast through the paper fiber and other contamination that accumulates on the printing surface. Therefore the nozzle tends only to push the paper fiber and other contamination down onto the printing surface instead of cleaning it off.

Another disadvantage of the present art is that the cleaning nozzle is located inside of (or integrated into) the vacuum chamber. Locating the cleaning head inside of vacuum chamber tends to cause the cleaning head to become contaminated with paper fiber and ink particles.

The prior art includes U.S. Pat. Nos. 5,603,775 and 5,644,986, U.S. Patent Publication No. U.S. 2002/018474 A1, and Japanese Patent Publication No. 63-4947. The '775 patent describes a cleaning device in which a liquid nozzle is positioned within a suction chamber of a nozzle head. The nozzle directs a jet of liquid perpendicularly against the surface of a rotating printing cylinder. Compressed air is supplied to the gap between the nozzle head and the printing cylinder.

The '986 patent describes a cleaning device which includes a plurality of nozzles for compressed air and liquid. The nozzles are located in a cleaning head adjacent to a vacuum chamber. The nozzles extend at an acute angle to a tangent to the printing cylinder but extend in the same direction as the rotation of the cylinder.

The U.S. Patent Publication describes a cleaning device which includes a liquid nozzle which is positioned within a suction chamber. The nozzle directs liquid perpendicularly against the surface of a plate cylinder.

The Japanese Patent Publication describes a cleaning device in which a high pressure air injection nozzle is positioned inside of a vacuum duct. The nozzle is directed perpendicularly against the plate cylinder. The vacuum duct forms an angle of 0° to 90° relative to the tangential direction of the plate cylinder.

### SUMMARY OF THE INVENTION

The invention uses a cleaning nozzle which is positioned at an acute angle which points in a direction which is opposite to the direction of rotation of the printing cylinder. The nozzle directs pressurized air and water to the edge of contamination on the printing surface of the cylinder. The angled spray of air and water tends to lift the contamination off of the printing surface more efficiently than a perpendicular spray. The nozzle is mounted on a cleaning head separate from a vacuum chamber in the cleaning head. Separating the nozzle from the vacuum chamber reduces the amount of paper fiber and ink and other contamination that can build up on the nozzle.

### DESCRIPTION OF THE DRAWING

The invention will be explained in conjunction with illustrative embodiments shown in the accompanying drawing in which—

FIG. 1 is a fragmentary side elevational view of a cleaning apparatus formed in accordance with the invention;

FIG. 2 is an enlarged fragmentary view of the cleaning apparatus of FIG. 1;

FIG. 3 is a plan view of the cleaning head taken along the line 3-3 of FIG. 2;

FIG. 4 is a sectional view of the cleaning nozzle;

FIG. 5 is a sectional view of the fluid cap of the nozzle before the fluid cap is modified;

FIG. 6 is a side elevational view of the nozzle insert;

FIG. 7 is a side elevational view of the spacer of the nozzle;

FIG. 8 is a front end view of the spacer;

FIG. 9 is another embodiment of the cleaning apparatus in which the nozzle is adjustably mounted on the cleaning head, with the nozzle adjusted to the minimum angle relative to the surface of the plate cylinder;

FIG. 10 is a view similar to FIG. 8 with the nozzle adjusted to the maximum angle;

FIG. 11 is a schematic diagram of the pneumatic control circuit for the nozzle;

FIG. 12 illustrates the mechanism for supplying pressurized water to the nozzle; and

FIG. 13 illustrates the vacuum system for providing suction to the cleaning head.

### DESCRIPTION OF SPECIFIC EMBODIMENTS

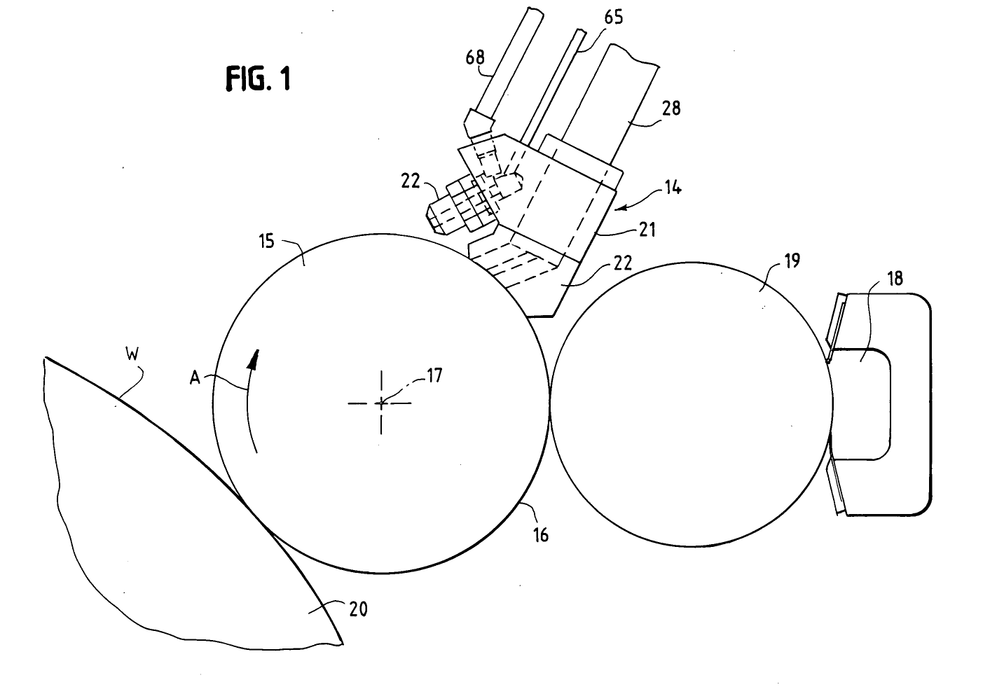

Referring to FIG. 1, a cleaning apparatus 14 is mounted adjacent a rotating cylinder 15. In the particular embodiment illustrated the cylinder is a plate cylinder of a flexographic printing press. The cylinder includes a cylindrical surface 16 which rotates about a longitudinal axis 17 in the direction of the arrow A.

Ink from a ink chamber 18 is supplied to the plate cylinder 15 by an anilox roll 19. A web W rotates with impression cylinder 20, and ink is transferred from the plate cylinder to the web.

The cleaning head is positioned to clean the plate after the ink is transferred to the web. Depending on the rotation of the plate roll, the cleaning head can be mounted above the axis between the anilox roll and plate roll, or below the axis between the plate roll and anilox roll.

As described in the prior art patents, the cleaning apparatus is mounted on a frame in a conventional manner which permits the cleaning apparatus to move axially along the plate cylinder for cleaning the plate cylinder as the plate cylinder rotates.

In general, the plate cleaner head traverses across the plate cylinder at a constant rate. The rate is selected to give uniform cleaning to all parts of the printing surface of the plate roll. However, there are cases where some areas of the print are more prone to contamination than others. Because of this, the traverse speed of the plate cleaner head can be varied. In “hard-to-clean” areas, the cleaning head speed may be slowed down, or stopped. In other cases, the cleaning head speed may be increased to traverse areas of no print.

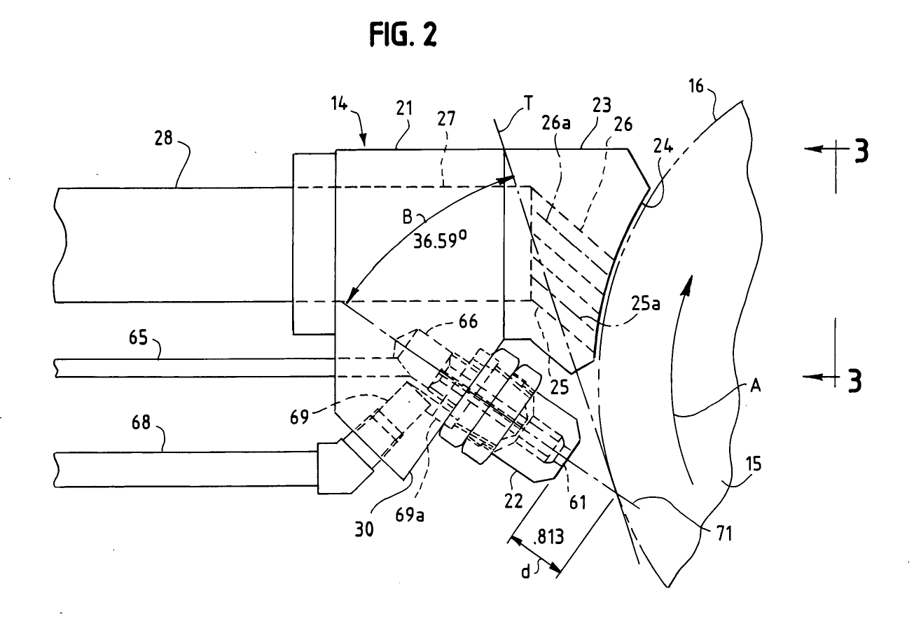

The cleaning apparatus 14 includes a cleaning head 21 and a nozzle 22 which is mounted on the cleaning head. Referring to FIG. 2, the cleaning head includes a suction head 23 with a curved bottom surface 24 which has substantially the same curvature as the cylinder 15 and which is spaced a short distance from the surface of the cylinder, for example, about 0.05 inch.

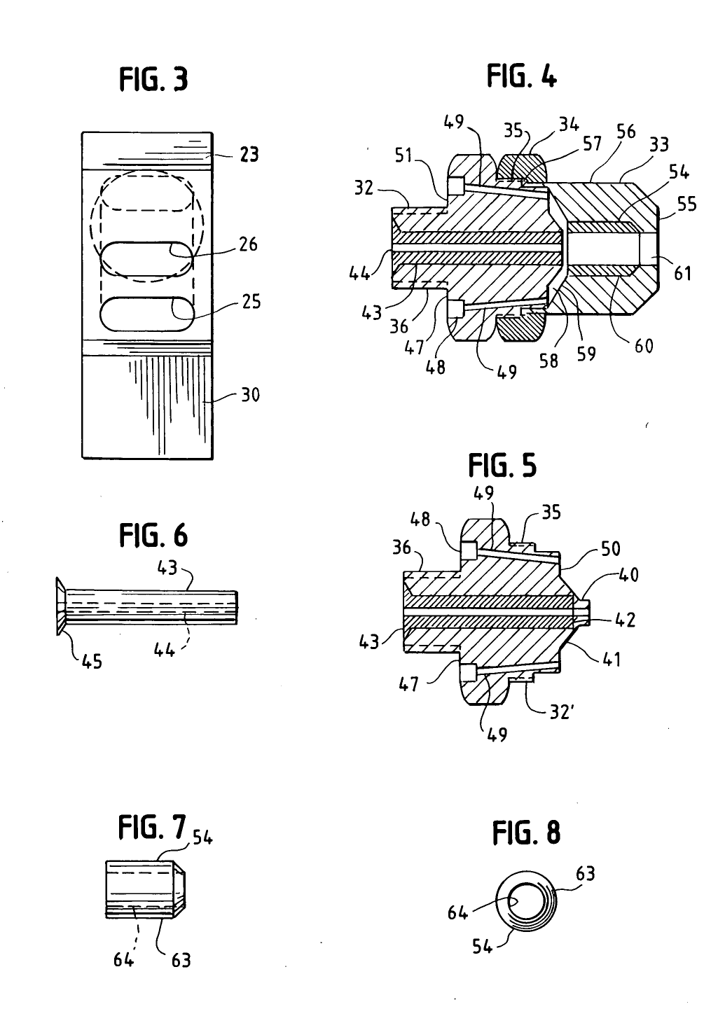

A pair of generally oval vacuum or suction ports 25 and 26 (see also FIG. 3) are provided in the suction head, and the vacuum ports are angled relative to the surface of the cylinder in a direction opposite to the direction of rotation of the cylinder. The longitudinal axes 25a and 26a of the suction ports extend at an acute angle relative to a tangent to the surface of the cylinder. The vacuum ports communicate with a cylindrical bore 27 in the cleaning head, and a vacuum tube 28 is connected to the bore.

The nozzle 22 is mounted on an angled mounting face 30 on the cleaning head which extends away from the vacuum head 23. Referring to FIGS. 4 and 5, the nozzle includes a fluid cap 32 and an air cap 33. The air cap is retained on the fluid cap by a retainer ring 34 which is retained by threads 35 on the fluid cap. The fluid cap includes a threaded rear projection 36 which is screwed into a threaded bore in the cleaning head.

FIG. 5 illustrates a commercially available fluid cap 32′ before it is modified for use in the invention. The unmodified fluid cap and air cap are available from Spraying Systems Co. of ______.

The unmodified fluid cap includes a front cylindrical projection 40 (FIG. 5) which extends forwardly from a conical front wall 41 of the fluid cap. The fluid cap is modified by cutting off the front projection at the cut line 42. The fluid cap is also modified by inserting a generally cylindrical nozzle insert 43 (see also FIG. 6) into the central fluid passage of the fluid cap. The nozzle insert has a much smaller fluid passage 44, which in the embodiment illustrated had a diameter of 0.062 inch. The nozzle insert has a flared flange 45 at the rear end which engages a correspondingly shaped flared surface on the fluid cap.

An annular rear wall 47 extends radially outwardly from the rear projection 36, and an annular channel 48 is formed in the wall 47. A plurality of air passages 49 extend from the channel 48 to an annular front wall 50 which extends radially outwardly from the conical front wall 41. A gasket 51 is positioned between the channel 48 and the cleaning head and provides a seal between the cleaning head and the nozzle.

The air cap 33 is also commercially available from Spraying Systems Co. However, the air cap is modified by inserting a generally cylindrical spacer 54 (see also FIGS. 7 and 8) in the air cap.

The air cap 33 includes a front wall 55 and a cylindrical side wall 56. A flange 57 at the rear end of the cylindrical wall is engaged by the retainer ring 34. An internal cavity 58 is formed by a conical surface 59 and the conical front wall 41. An orifice 61 extends from the cavity through the front wall 55.

The spacer 54 is sized to fit snugly within cylindrical surface 60 of the air cap and reduces the effective diameter of the cylindrical portion of the internal cavity 58. In the embodiment illustrated the spacer had a cylindrical side wall 63 (FIGS. 7 and 8) with a diameter of 0.421±0.005 inch and a bore 64 with a diameter of 0.250 inch. The length of the spacer was 0.563 inch. Referring to FIGS. 1 and 2, a fluid supply tube 65 is connected to the cleaning head 21 and supplies pressurized water or other cleaning fluid to an internal water passage 66 in the cleaning head. The water passage 66 communicates with the fluid passage 44 of the nozzle insert 43.

An air supply tube 68 is connected to the cleaning head and supplies pressurized air to an internal air passage 69 in the cleaning head. The air passage 69 includes an annular portion 69a which communicates with the channel 48 in the fluid cap.

The pressurized air flows through the air passages 49 in the fluid cap, and the pressurized water flows through the fluid passage 44 of the nozzle insert 43. The air and water mix together in the bore 64 of the spacer 54 in the air cap and are ejected from the orifice 61 of the air cap as an atomized spray.

Referring to FIG. 2, the orifice 61 has a longitudinal axis 71 which is aligned with the centerlines of the spacer 54 and nozzle insert 43. The nozzle 22 is mounted on the cleaning head so that the axis 71 forms an acute angle B with a tangent T to the cylindrical surface 16 at the point where the axis 71 intersects the cylindrical surface. The angle B is formed by the axis 71 and the portion of the tangent T which extends in the direction of rotation of the cylinder.

FIGS. 1 and 2 illustrate a plate cylinder 15 having a diameter of 9.5 inches. For that size plate cylinder running at a web speed of 2500 feet per minute, the angle B which provided the best results was 36.59°, and the distance d between the orifice of the nozzle 22 and the intersection of the axis 71 with the plate cylinder was 0.813 inch.

The angle B can be varied depending upon the size of the plate cylinder, the web speed, and other variables. The angle can vary between about 30° to and about 80°, preferably between about 35° and 76°. We have found that smaller acute angles in the range of about 30° to about 50° work best, and preferably within the range of about 30° to about 40°.

During the printing process, the cleaning head moves across the printing surface. The printing surface is cleaned continuously by the plate cleaner while the press is in operation. Mounting the nozzle at the angle B directs the cleaning spray in a direction opposite the direction of the moving printing surface. This opposite spraying action tends to direct the force of the cleaning spray at the edge of the contamination. The angled spray tends to lift the contamination off of the printing surface more efficiently than a perpendicular spray.

Contamination which is removed from the printing surface is vacuumed from the printing surface by the suction at the suction ports 25 and 26 as the printing surface moves past the ports. The suction ports are located downstream from the nozzle in the direction in which the plate cylinder locates. The nozzle is separated from the suction ports, and the suction does not draw the contamination past the nozzle, thereby reducing the amount of paper fiber, ink, and other contamination that can build up on the nozzle.

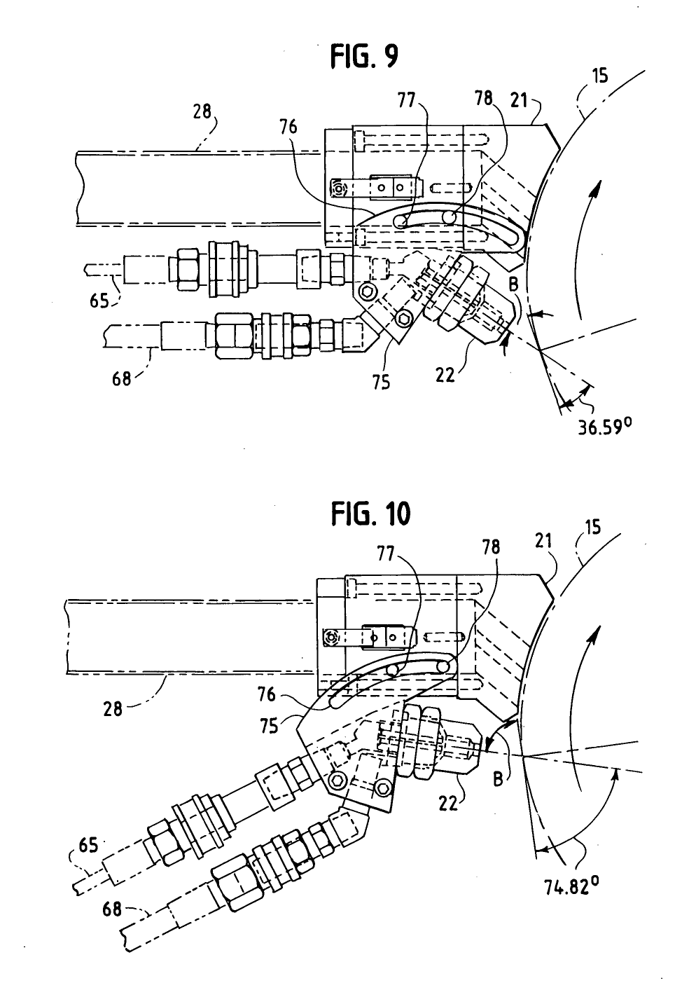

FIGS. 9 and 10 illustrate a modified embodiment of the cleaning apparatus in which the nozzle is adjustably mounted on the cleaning head. A bracket 75 is attached to the nozzle 22 and is provided with a curved slot 76. A pair of fastening screws 77 and 78 on the cleaning head 21 extend through the slot. In FIG. 9 the fastening screw 77 engages the left end of the slot 76, and the acute angle B is at its minimum value. In the specific embodiment illustrated in FIG. 9, the minimum angle is 36.59°.

In FIG. 10 the fastening screw 78 engages the right end of the slot 76, and the acute angle B is at its maximum value. In the specific embodiment illustrated in FIG. 10, the maximum angle is 74.82°.

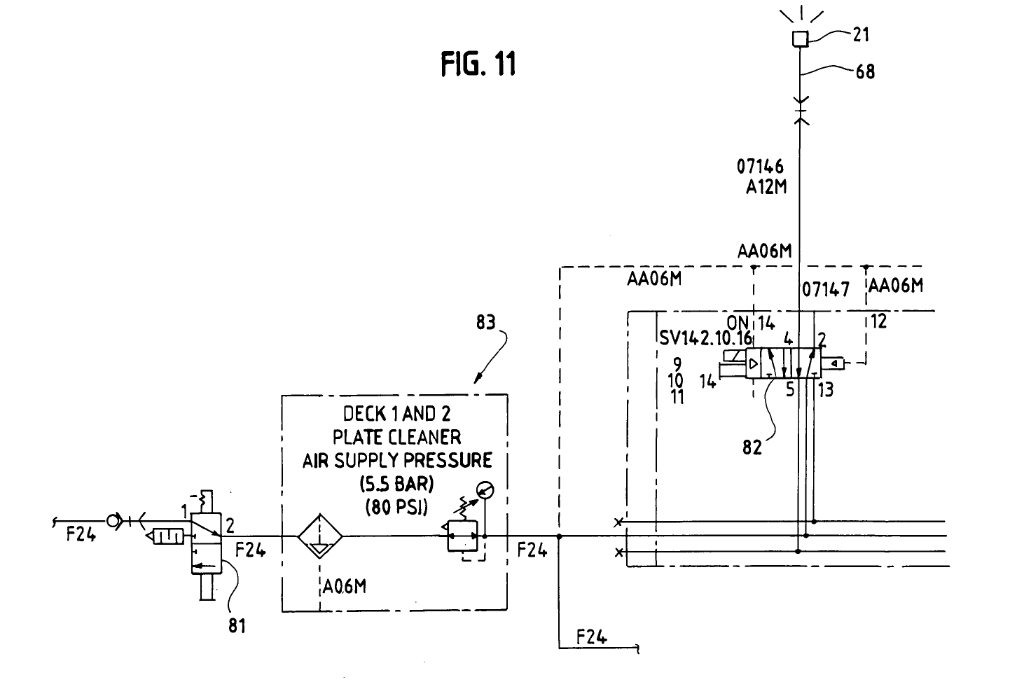

FIG. 11 is a schematic diagram of pneumatic control circuit for the cleaning apparatus. Pressurized air is supplied through air tube 68 to the nozzle of the cleaning head 21 by valves 81 and 82. A filter/regulator assembly 83 is positioned between the valves.

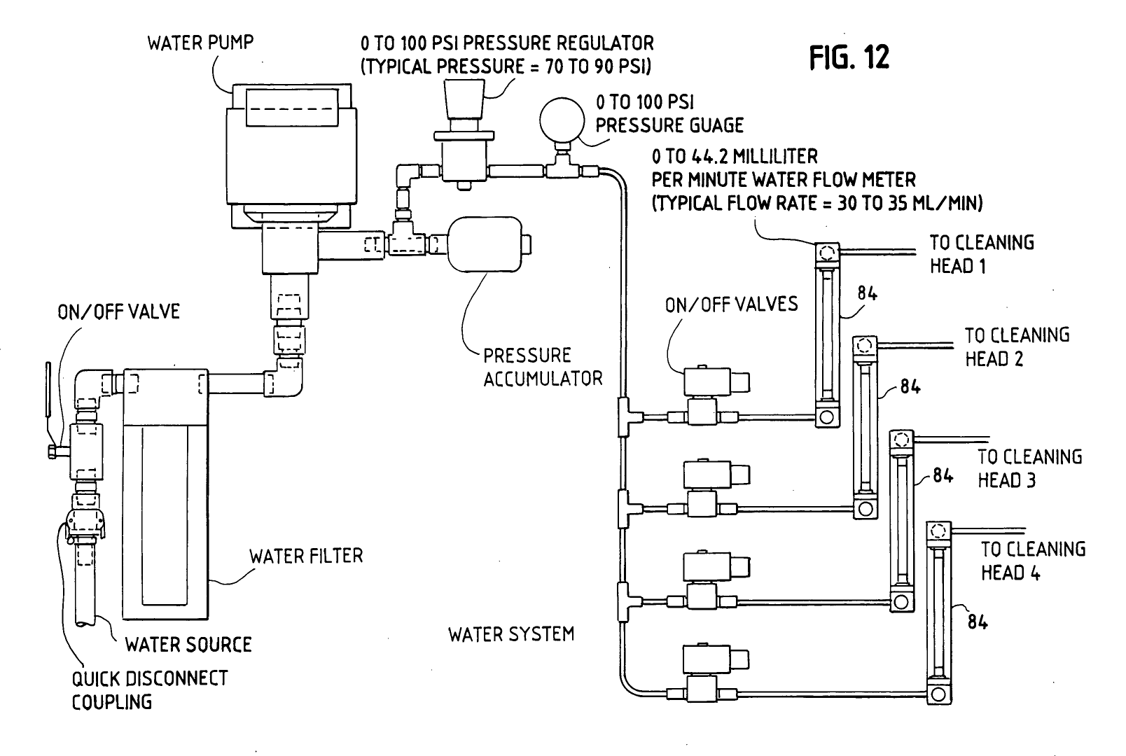

FIG. 12 illustrates the control circuit for supplying water through four water tubes 65a, 65b, 65c, and 65d to the nozzles of four cleaning heads which clean the plate cylinders of four printing decks of a flexographic press. The water flow rate is controlled by water flow meters 84. It is very important to set the correct water flow rate. For instance, maximum cleaning is achieved when the water flow is maximized, however if too much water is applied to the printing surface of the plate roll, the print in the area of the cleaning head, will be temporarily lightened (or washed ut). Washed-out print is unacceptable.

At higher speed, more water can be applied to the printing surface of the plate roll before wash-out will occur. This is because the web carries some of the water away. As the machine speed is increased, more web is passing the plate roll in a given amount of time. Because of this, the water flow rate can be varied with machine speed to get the most effective cleaning at all speeds. The air flow rate and the vacuum can also be changed with speed, but these have a less important role in cleaning.

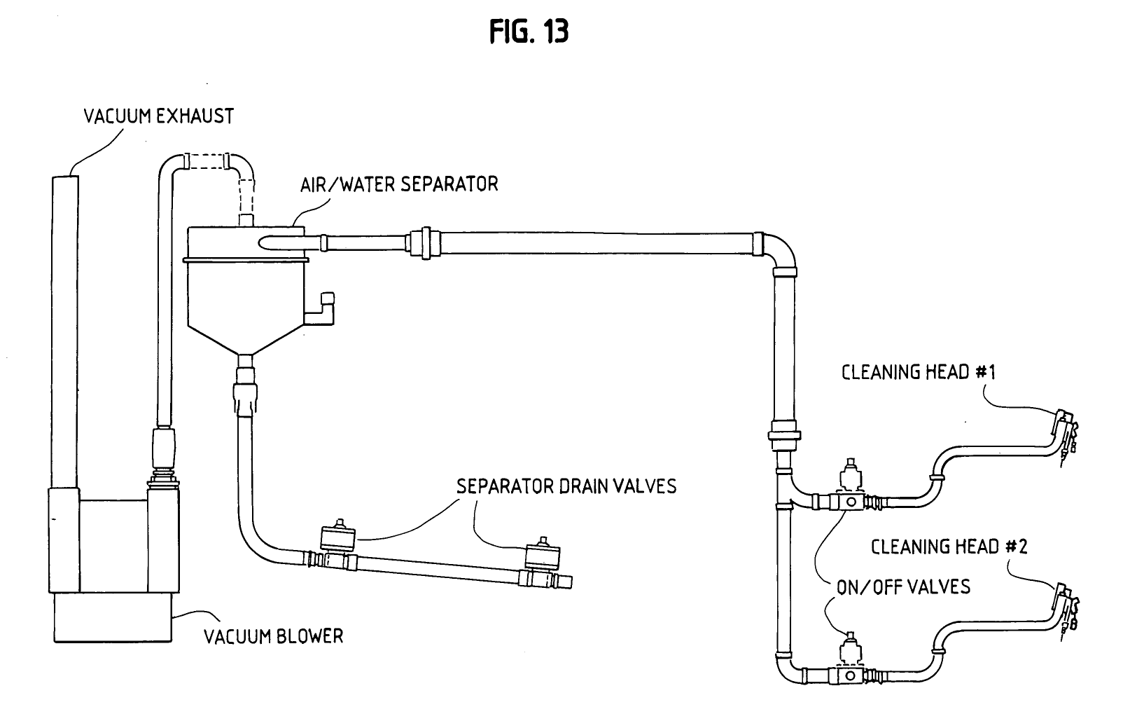

FIG. 13 illustrates the vacuum system for providing suction through two vacuum tubes 28a and 28b to the cleaning heads for two printing decks.

While in the foregoing specification a detailed description of specific embodiments was set forth for the purpose of illustration, it will be understood that many of the details hereingiven may be varied considerably without departing from the spirit and scope of the invention.

1. Apparatus for cleaning the surface of a rotating cylinder, the cylinder having a longitudinal axis and a cylindrical surface and being rotatable about said longitudinal axis, comprising:
a nozzle for directing pressurized fluid toward the cylindrical surface, the nozzle having an orifice with a longitudinal axis along which the pressurized fluid is directed, the axis of the orifice forming an acute angle with a tangent to the cylindrical surface at the point at which the axis of the orifice intersects the cylindrical surface, the tangent extending in the direction in which the cylindrical surface rotates, and
a cleaning head having a suction port adjacent the cylindrical surface, the suction port being positioned downstream from the nozzle in the direction in which the cylindrical surface rotates.

2. The apparatus of claim 1 in which said acute angle is within the range of about 30° to about 80°.

3. The apparatus of claim 1 in which said acute angle is within the range of about 35° to about 76°.

4. The apparatus of claim 1 in which said acute angle is within the range of about 30° to about 50°.

5. The apparatus of claim 1 in which said acute angle is within the range of about 30° to about 40°.

6. The apparatus of claim 1 in which said nozzle is mounted on said cleaning head and is spaced from the suction port.

7. The apparatus of claim 6 in which said suction port has a longitudinal axis which forms an acute angle with a tangent to the cylindrical surface at the point at which the axis of the suction port intersects the cylindrical surface, the tangent extending in the direction in which the cylindrical surface rotates.

8. Apparatus for cleaning the surface of a rotating cylinder, the cylinder having a longitudinal axis and a cylindrical surface and being rotatable about said longitudinal axis, comprising:
a nozzle for directing pressurized fluid toward the cylindrical surface, the nozzle having an orifice with a longitudinal axis along which the pressurized fluid is directed, the axis of the orifice forming an acute angle with a tangent to the cylindrical surface at the point at which the axis of the orifice intersects the cylindrical surface, the tangent extending in the direction in which the cylindrical surface rotates, and
a cleaning head having a suction port adjacent the cylindrical surface, the suction port being positioned downstream from the nozzle in the direction in which the cylindrical surface rotates,
said nozzle being mounted on said cleaning head and being spaced from the suction port,
said suction port having a longitudinal axis which forms an acute angle with a tangent to the cylindrical surface at the point at which the axis of the suction port intersects the cylindrical surface, the tangent extending in the direction in which the cylindrical surface rotates,
the cleaning head including a curved surface which is spaced from the cylindrical surface, the suction port being located in the curved surface, the nozzle being spaced from the curved surface.

9. The apparatus of claim 1 in which said pressurized fluid is a mixture of air and liquid.

10. The apparatus of claim 1 in which the nozzle includes a fluid cap having a rear end and a front end, a central fluid passage extending between the rear end and the front end, and at least one air passage in the front end offset from the central fluid passage, and an air cap mounted on the fluid cap and covering the front end of the fluid cap, said orifice being provided in the air cap.

11. The apparatus of claim 10 in which the air cap is provided with an internal cavity which has a diameter greater than the diameter of the orifice.

12. The apparatus of claim 11 in which the diameter of the orifice is greater than the diameter of the central fluid passage.

13. The apparatus of claim 10 in which the diameter of the orifice is greater than the diameter of the central fluid passage.

14. Apparatus for cleaning the surface of a rotating cylinder, the cylinder having a longitudinal axis and a cylindrical surface and being rotatable about said longitudinal axis, comprising:
a nozzle for directing pressurized fluid toward the cylindrical surface, the nozzle having an orifice with a longitudinal axis along which the pressurized fluid is directed, the axis of the orifice forming an acute angle with a tangent to the cylindrical surface at the point at which the axis of the orifice intersects the cylindrical surface, the tangent extending in the direction in which the cylindrical surface rotates, and
a cleaning head having a suction port adjacent the cylindrical surface, the suction port being positioned downstream from the nozzle in the direction in which the cylindrical surface rotates,
said nozzle being mounted on said cleaning head and being spaced from the suction port,
said suction port having a longitudinal axis which forms an acute angle with a tangent to the cylindrical surface at the point at which the axis of the suction port intersects the cylindrical surface, the tangent extending in the direction in which the cylindrical surface rotates,
the nozzle including a fluid cap having a rear end and a front end, a central fluid passage extending between the rear end and the front end, and at least one air passage in the front end offset from the central fluid passage, and an air cap mounted on the fluid cap and covering the front end of the fluid cap, said orifice being provided in the air cap, the air cap being provided with an internal cavity which has a diameter greater than the diameter of the orifice, and
a cylindrical insert which extends through the fluid cap and which provides the central fluid passage.

15. Apparatus for cleaning the surface of a rotating cylinder, the cylinder having a longitudinal axis and a cylindrical surface and being rotatable about said longitudinal axis, comprising:
a nozzle for directing pressurized fluid toward the cylindrical surface, the nozzle having an orifice with a longitudinal axis along which the pressurized fluid is directed, the axis of the orifice forming an acute angle with a tangent to the cylindrical surface at the point at which the axis of the orifice intersects the cylindrical surface, the tangent extending in the direction in which the cylindrical surface rotates, and
a cleaning head having a suction port adjacent the cylindrical surface, the suction port being positioned downstream from the nozzle in the direction in which the cylindrical surface rotates,
said nozzle being mounted on said cleaning head and being spaced from the suction port,
said suction port having a longitudinal axis which forms an acute angle with a tangent to the cylindrical surface at the point at which the axis of the suction port intersects the cylindrical surface, the tangent extending in the direction in which the cylindrical surface rotates,
the nozzle including a fluid cap having a rear end and a front end, a central fluid passage extending between the rear end and the front end, and at least one air passage in the front end offset from the central fluid passage, and an air cap mounted on the fluid cap and covering the front end of the fluid cap, said orifice being provided in the air cap, and
a cylindrical insert which extends through the fluid cap and which provides the central fluid passage.

16. The apparatus of claim 1 including a water tube for supplying water to the nozzle and a water flow meter connected to the water tube whereby the water flow rate can be varied with the speed of rotation of the cylinder to get the most effective cleaning at all speeds.

17. The apparatus of claim 1 in which the cleaning head includes a curved surface which is spaced from the cylindrical surface, the suction port being located in the curved surface, the nozzle being spaced from the curved surface.
